(19) United States
(12) Patent Application Publication
(10) Pub. No.: US 2026/0302958 A1
(43) Pub. Date: Oct. 1, 2026

(54) SHORT CIRCUIT CURRENT LIMIT FOR OPEN LOOP LLC CONVERTER

(71) Applicant: Murata Manufacturing Co., Ltd., Nagaokakyo-shi (JP)

(72) Inventor: Frank WARNES, Milton Keynes (GB)

(21) Appl. No.: 19/576,337

(22) Filed: Mar. 24, 2026

(30) Foreign Application Priority Data
Mar. 26, 2025 (GB) 2504472.8

(51) Int. Cl. H02M 3/335; H02H 7/12; H02M 1/088; H02M 3/00

(52) U.S. Cl. CPC H02M 3/33571; H02H 7/1213; H02M 1/088; H02M 3/01

(57) ABSTRACT

A short-circuit protection circuit for a resonant half-bridge circuit including a resonant capacitor coupled to a transformer winding of the resonant half-bridge circuit to detect a voltage indicative of a short circuit in the half-bridge circuit, the short-circuit protection circuitry including a sensing circuit coupled to the resonant capacitor to generate a triggering voltage in response to a voltage increase across the resonant capacitor due to a short circuit in the half-bridge circuit, and a controlling circuit coupled between a voltage input of the half-bridge circuit and the sensing circuit to shut down the half-bridge circuit when the triggering voltage is received in response to the short circuit in the half-bridge circuit.

### CROSS REFERENCE TO RELATED APPLICATIONS

This application claims the benefit of priority to British Patent Application No. 2504472.8 filed on Mar. 26, 2025. The entire contents of this application are hereby incorporated herein by reference.

### BACKGROUND OF THE INVENTION

### 1. Field of the Invention

The present invention relates to short-circuit protection circuitry for resonant half-bridge topologies and related methods.

### 2. Description of the Related Art

The open loop resonant half-bridge or an open loop LLC topology is currently being used more and more in low power isolated circuits. This is due to its ability to drive a poorly coupled transformer with high leakage inductance without the usual losses associated with non-resonant converters. This makes the topology ideally suited for high isolation transformers in applications such as gate driver power devices. At the moment, there are very few controllers available and in many cases it is easier and cheaper to use a standard half-bridge driver integrated circuit to build the circuitry.

FIG. 1 shows an example of a known LLC resonant half-bridge circuit 100 with a transformer TX1 including a primary side 101 and a secondary side 102. The primary side 101 of the half-bridge circuit 100 includes a primary winding PRI101, and two transistors TR101 and TR102. The primary side 101 of the half-bridge circuit 100 is configured to alternately turn transistor TR101 ON and transistor TR102 OFF, and vice versa, providing an alternating voltage of equal magnitude across the primary winding PRI101. The secondary side 102 of the half-bridge circuit 100 includes a secondary winding PRI102 and a voltage doubler rectifier circuit including diodes D101 and D102, and capacitors C101 and C102. The secondary side 102 is configured to provide an output of DC voltage.

As also shown in FIG. 1, at the primary side 101 a standard LLC resonant circuit is formed by a resonant capacitor, Cᵣₑₛ; a parasitic leakage inductance of the transformer, Lₗₑₐₖ, which is essentially any part of the primary winding that is not coupled to the secondary winding; and a true magnetic inductance of the primary winding, L_{mag}. For the circuit to be resonant the following criterion must be met:

$${F}_{res} = \frac{1}{2 π \sqrt{{L}_{leak} {C}_{res}}}$$

where Fᵣₑₛ is the square-wave switching frequency, and Lₗₑₐₖ and Cᵣₑₛ are the primary side leakage inductance and capacitance. When Cᵣₑₛ and Lₗₑₐₖ are set to be resonant at the switching frequency, this leads to the effect of cancelling the reduction in coupling caused by the leakage inductance.

The primary winding PRI101 of the transformer TX1 receives a square-wave voltage which is then transferred to the secondary side 102, with the transformer providing both electrical isolation and the required turns ratio to deliver the desired voltage level to the output. FIG. 2 shows that at the resonant frequency, the output current waveform changes from a square current pulse (waveform 201) with inductive slope to an almost sinusoidal waveform (waveform 202). This has the advantage that, at the start and finish of each cycle, the current is zero, and hence the switching losses (=V×I) are zero.

One disadvantage of this however is that short circuit protection is usually not available. Conventionally, a buck converter or a linear regulator incorporating current limit can be added either before or after the half-bridge configuration. However, this normally requires extra components added to the circuit. Therefore, it is desirable to provide a simple circuitry and a simple method to incorporate short circuit protection in a resonant half-bridge topology taking advantage of an existing set up of the half-bridge circuitry.

### SUMMARY OF THE INVENTION

An example embodiment of the present invention provides a short-circuit protection circuit for a resonant half-bridge circuit including a resonant capacitor coupled to a transformer winding of the half-bridge circuit to detect a voltage indicative of a short circuit in the half-bridge circuit, the short-circuit protection circuitry including a sensing circuit coupled to the resonant capacitor to generate a triggering voltage in response to a voltage increase across the resonant capacitor due to a short circuit in the half-bridge circuit, and a controlling circuit coupled between a voltage input of the half-bridge circuit and the sensing circuit to shut down the half-bridge circuit when the triggering voltage is received in response to the short circuit in the half-bridge circuit.

According to an example embodiment of the present invention, a short circuit protection circuit is provided in which current sensing is done by monitoring the voltage across an existing primary side decoupling capacitor. As a consequence, the protection is completely lossless and does not require a separate sense resistor or current transformer, few additional components are used, and in most cases, an existing enable pin or unused input signal pin can be used to trigger shutdown of a connected gate driver circuit. A hiccup type operation can be used to minimize the average power loss during a short circuit.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a schematic circuit diagram of a known LLC resonant half-bridge circuit 100 without a short-circuit protection.

FIG. 2 shows that an output a current waveform changes at the resonant frequency from a square current pulse (waveform 201) to a an almost pure sinusoidal waveform (waveform 202) through the LLC resonant half-bridge converter shown in FIG. 1.

FIG. 3 shows a schematic circuit diagram of a resonant half-bridge circuit 300 including a short-circuit protection circuitry 310 according to a first example embodiment of the present invention.

FIG. 4 shows a resonant half-bridge circuitry 400 including a short-circuit protection circuitry 410 according to a second example embodiment of the present invention.

FIG. 5 shows a resonant half-bridge circuitry 500 including a short-circuit protection circuitry 510 according to a third example embodiment of the present invention.

FIG. 6 shows a resonant half-bridge circuitry 600 including a short-circuit protection circuitry 610 in a real application based on the second example embodiment of the present invention shown in FIG. 4.

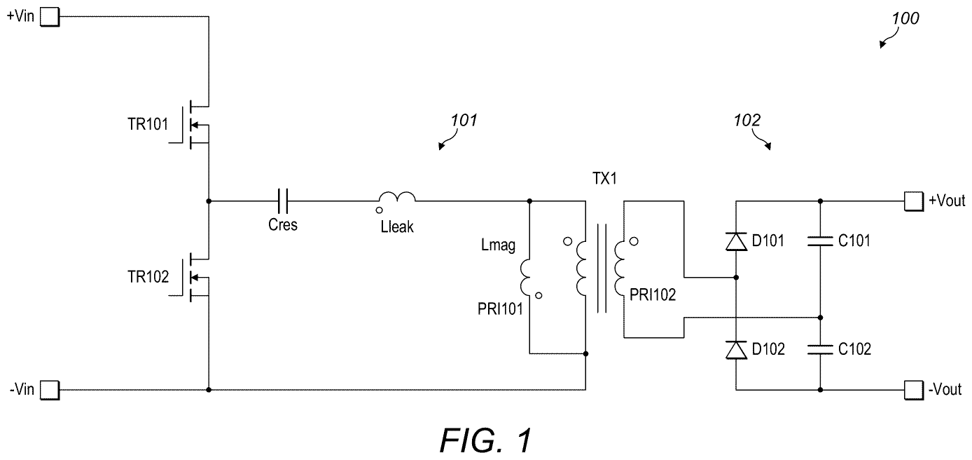

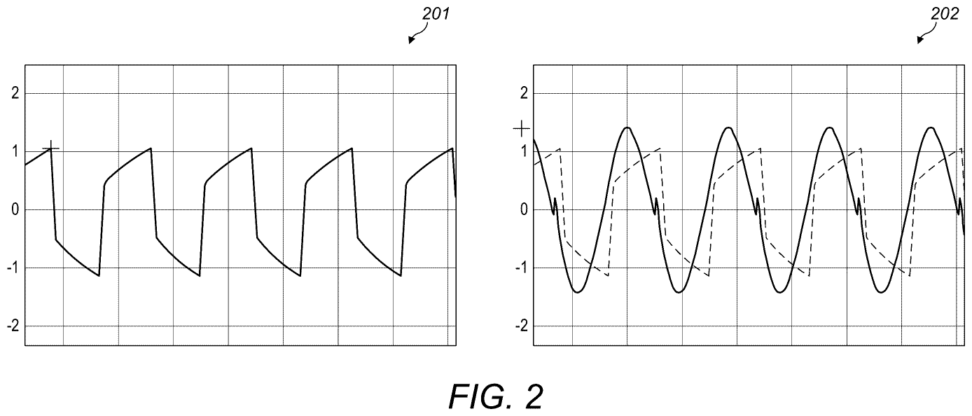

### DETAILED DESCRIPTION OF THE EXAMPLE EMBODIMENTS

Example embodiments of the present invention relates to short circuit protection circuitry suitable for a resonant half-bridge topologies. In the example embodiments, the short-circuit protection circuitry for a resonant half-bridge circuit includes a resonant capacitor being indicative of a short circuit in the half-bridge circuit, the short-circuit protection circuitry includes a sensing circuit coupled to the resonant capacitor to generate a triggering voltage in response to a voltage increase across the resonant capacitor due to a short circuit in the half-bridge circuit, and a controlling circuit coupled between a voltage input of the half-bridge circuit and the sensing circuit to shut down the half-bridge circuit when the triggering voltage is received in response to the short circuit in the half-bridge circuit.

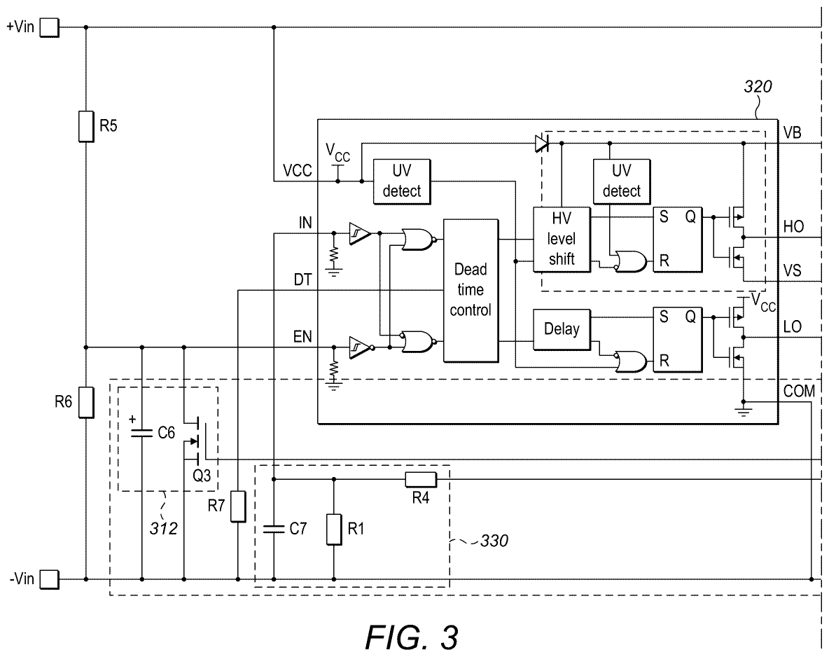

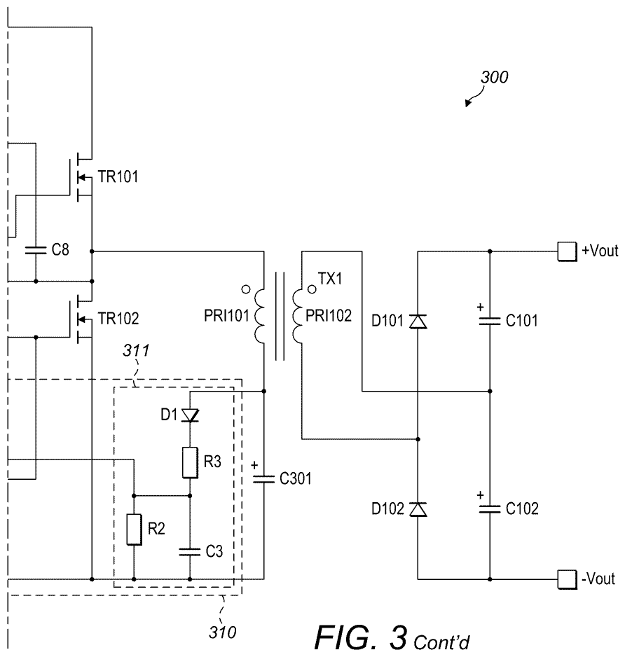

FIG. 3 shows a schematic circuit diagram of a resonant half-bridge circuit 300 including a short-circuit protection circuitry 310 according to a first example embodiment of the present invention. The half-bridge circuit 300 includes a transformer TX1 including a primary side and a secondary side. The primary side of the half-bridge circuit 100 includes a primary winding PRI101, two transistors TR101 and TR102 coupled to the primary winding PRI101, and a gate driving integrated circuit (IC) 320 to drive the two transistors TR101 and TR102. In some example embodiments, the transistors are metal-oxide-semiconductor field-effect transistors (MOSFETS).

The gate driving IC 320 is configured to drive both MOSFETS TR101 and TR102 with gate signals of opposing polarity. A dead time is needed between the consecutive transitions. This is to prevent that both MOSFETS TR101 and TR102 being in an ON state at the same time and to prevent shoot-through current. The gate driving IC 320 is therefore also configured to have a dead time control. As shown in FIG. 3, in this example embodiment, the dead time control for the gate driver IC 320 is set by a resistor R7 connected to the negative voltage line −Vin. The gate driving IC 320 may be any gate driver having a function of providing a power input for the gates of the transistors TR101 and TR102.

The primary side of the transformer TX1 further is connected to a resonant capacitor C301, wherein the resonant capacitor is connected at the other of its terminals to the voltage input −Vin. This allows the voltage across the resonant capacitor C301 to be monitored with respect to the voltage input −Vin.

The secondary side of the half-bridge circuit 300 includes a secondary winding PRI102 and a voltage doubler rectifier circuit including diodes D101 and D102, and capacitors C101 and C102.

In a normal operation of the half-bridge circuit 300, an oscillation is set up in the half-bridge circuit by the gate driving IC 320 and a duty cycle control circuit 330 including a capacitor C7 and two resistors R1 and R4. The resistor R4 is coupled between an input (e.g., IN input) and an output (e.g., LO output) of the gate driving IC 320. The capacitor C7 and the resistor R1 are connected in parallel and are both coupled to the voltage input −Vin. The Schmitt trigger relaxation oscillator technique is used in which the LO output of the half-bridge gate driving IC 320 is connected back into the IN input of the half-bridge gate driving IC 320 via the resistor R4, connected between the IN input and the voltage input −Vin via the capacitor C7 and the resistor R1.

At start up, the IN input is low and the LO output is high. The voltage on C7 therefore starts to charge up until it reaches the high level Schmitt trigger voltage. At this point, the LO output goes low and the voltage on C7 starts to discharge. When the voltage on C7 reaches the low Schmitt trigger voltage, the LO output goes high again and the cycle restarts. By selecting the values of C7, R1 and R4 carefully, a square-wave profile with a 50% duty cycle running at a particular frequency can be generated at the output of the half-bridge circuit.

A power input is set up through the gate driving IC 320 to the half-bridge circuit. As shown in FIG. 3, an enabling input EN of the gate driving IC 320 is set to receive a voltage provided at the intermediate node of the voltage divider including resistors R5 and R6 connected across terminals +Vin and −Vin. The voltage divider can be configured to apply a voltage (e.g., a logic 5V signal) when the input voltage is applied. An enabling capacitor C6 is connected in parallel across the resistor R6 and is configured to provide a small delay time before the gate driving IC 320 starts to operate. In some example embodiments, the enabling capacitor C6 may be included in the short-circuit protection circuitry 310.

As described above, an oscillation in the circuit and a power input can both be set up using the gate driving IC 320. However, the gate driving IC 320 does not provide a short-circuit protection function to the circuit. In this example embodiment, the short circuit protection circuitry 310 has therefore been incorporated into the circuit. Specifically, the short circuit protection circuitry 310 is incorporated into the half-bridge circuit at the primary side of the transformer TX1.

The short-circuit protection circuitry 310 is configured to detect a short circuit in the circuit and is configured to shut down the circuit in response to the detection of a short circuit. Therefore, the short circuit protection circuitry 310 at least includes a sensing circuit 311 and a controlling circuit 312.

In order to take advantage of existing components in the half-bridge circuit, the sensing circuit 311 is coupled to the resonant capacitor C301. As described above, the resonant capacitor C301 is connected or referenced to the voltage input −Vin which allows the voltage across the resonant capacitor C301 to be monitored with respect to the voltage input −Vin. This resonant capacitor C301 is used by the short-circuit protection circuitry 310 as a reference component indicative of a short circuit in the half-bridge circuit. During a short circuit, a peak voltage across the resonant capacitor C301 increases significantly compared to the voltage during a normal operation. Hence, the sensing circuit 311 is coupled to the resonant capacitor C301 to monitor any voltage increase across the resonant capacitor C301. This circuit configuration achieves a current sensing by monitoring voltage across the existing resonant capacitor at the primary side, so it is completely lossless and does not require a sense resistor or current transformer.

The controlling circuit 312 is configured to shut down the half-bridge circuit by controlling the gate driver IC 320. In some example embodiments, the short circuit protection circuitry 310 shuts down the gate driver IC 320 through an EN (enabling) pin or an unused input signal pin of the gate driver IC 320. The short circuit protection circuitry 310 uses existing pins or operations to trigger the shutdown which avoids or at least reduces the need to use additional components.

Similarly, in order to take advantage of existing components in the half-bridge circuit, the controlling circuit 312 of the short-circuit protection circuitry 310 may be coupled to the enabling capacitor C6.

With the above-described circuit configuration, the short circuit protection circuitry 310, it is configured to generate a triggering signal when a voltage increase is sensed at the resonant capacitor C301. The generated triggering signal is transmitted to the controlling circuit 312, in which the controlling circuit 312 is operated to disable the power supply to the half-bridge circuit through the EN pin of the gate driver IC 320 to protect it from short circuit. A detailed circuit configuration is discussed as follow.

As shown in FIG. 3, the sensing circuit 311 of the short circuit protection circuitry 310 includes at least a triggering component coupled to the resonant capacitor C301. Since the resonant capacitor C301 has a function of being an indicator of a voltage increase due to a short circuit, the sensing circuit 311 is configured to detect such voltage increase across the resonant capacitor C301. The sensing circuit 311 is configured to generate a triggering signal, such as a triggering voltage, to the controlling circuit 312 when a short circuit is detected through the voltage change of the resonant capacitor C301. In some example embodiments, the triggering component of the sensing circuit 311 is a capacitor.

The controlling circuit 312 is configured to be responsive to the triggering signal generated by the sensing circuit 311 and to shut down the half-bridge circuit. The controlling circuit 312 of the short circuit protection circuitry 310 therefore includes at least a switch coupled to the sensing circuit 311, such that the controlling circuit is turned on when a triggering signal (e.g. a triggering voltage) is received. As shown in FIG. 3, the switch is a transistor Q3 and wherein the gate of the transistor Q3 is coupled to the sensing circuit 311 such that the triggering voltage generated by the sensing circuit 311 can switch on the transistor Q3. The other terminals of the transistor are connected between the −Vin line and the EN terminal of the gate driver IC 320.

As shown in FIG. 3, the sensing circuit 311 includes a first capacitor C3 as a triggering component. A diode D1 and a first resistor R3 are connected in series with the first capacitor C3. A second resistor R2 is in parallel with the first capacitor C3. The first R3 and second resistors R2 provide a voltage divider connected to the first capacitor C3. An intermediate node between the first and second resistors R3 and R2 of the sensing circuit 311 is taken to connect to the gate of the transistor Q3, such that any triggering voltage generated by the sensing circuit 311 is transmitted to the gate of the transistor Q3 of the controlling circuit 312.

During a normal operation with no short circuit, the voltage across the resonant capacitor C301 is a sinusoidal voltage centered at Vin/2. The peak to peak voltage is generally smaller than Vin but this may depend on series resistances such as the winding and field effect transistor resistance and the load applied to the output.

During a short circuit, the peak voltage across the resonant capacitor C301 is amplified greatly and can be higher than 5 Vin. This is due to the removal of the damping effect caused by the coupling of the secondary winding. Essentially, the primary inductance effectively becomes a pure leakage inductance. In the sensing circuit 311, the diode D1 of the protection circuitry 310 therefore rectifies the peak voltage and peak charges the triggering capacitor C3. The first and second resistors, R3 and R2, act as a voltage potential divider connected to the gate of the enabling transistor Q3 and also act as a delay in charging the triggering capacitor C3.

In operation, it is necessary to discriminate between a start up surge into a large output capacitor and an actual short circuit. The potential divider formed by the first and second resistors, R3 and R2, in the sensing circuit 311 is used to make sure that the gate of the transistor Q3 is not triggered during normal operation but is triggered during a short circuit. At this point, the transistor Q3 quickly discharges the capacitor C6 which causes the EN pin of the gate driver IC 320 to switch off and therefore causes a termination of gate pulses until the capacitor C6 charges back up.

By carefully adjusting the delays it is possible to set up a hiccup operation during short circuit where the duty cycle of the ON periods is low compared to the OFF period therefore greatly reducing losses in the circuit.

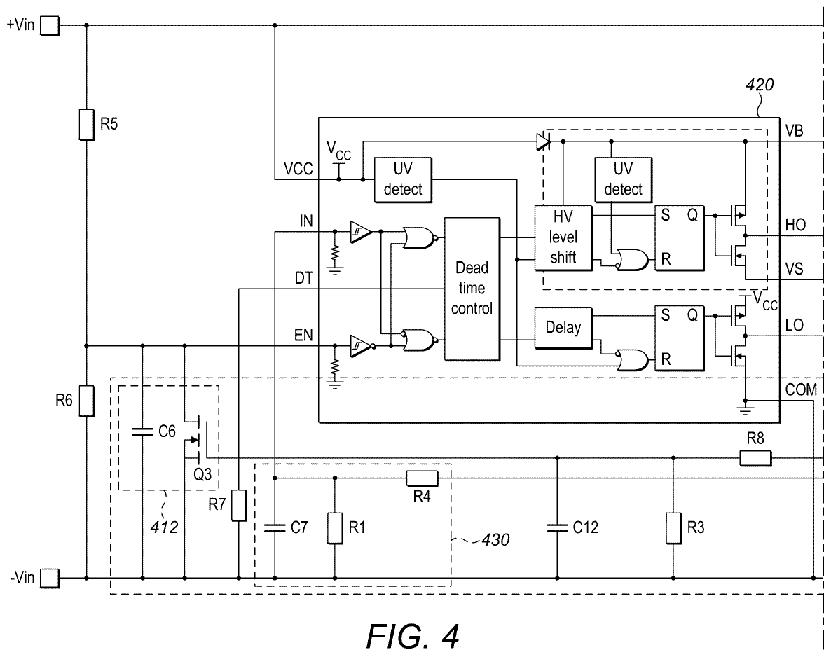

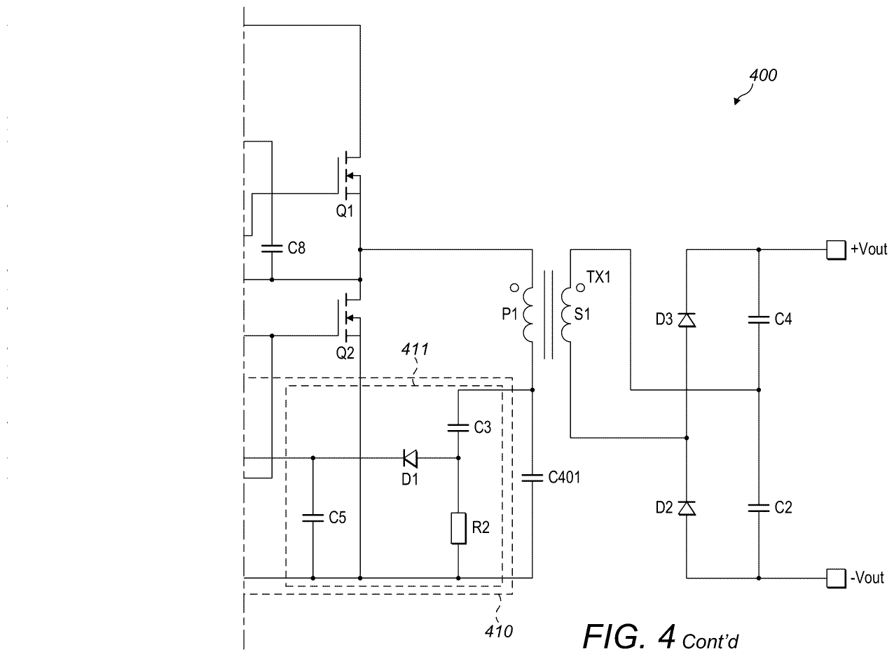

Setting up a hiccup mode of operation will also be explained in more detailed in connection with the second example embodiment illustrated in FIG. 4.

FIG. 4 shows a resonant half-bridge circuitry 400 including a short-circuit protection circuitry 410 according to a second example embodiment of the present invention. The short-circuit protection circuitry 410 includes a sensing circuit 411 and a controlling circuit 412. The controlling circuit 412 is the same as the controlling circuit 312 of the first example embodiment shown in FIG. 3. The sensing circuit 411 includes a capacitor C3 as a triggering component which is in parallel with a resonant capacitor C401 of the primary side and in series with a resistor R2.

Advantageously, with this circuit set up, the triggering capacitor C3 can be set to a capacitance value much smaller than the capacitance of the resonant capacitor C401 (e.g., about 10% of the capacitance of the resonant capacitor C401) and be configured to pass a small proportion of the resonant current through the resistor R2 during operation. The voltage across the resistor R2 is then proportional to the current in the triggering capacitor C3. The voltage across the resistor R2 is rectified by a diode D1 and is peak charged into a capacitor C5. The capacitor C5 acts as a hold-up for peak voltage and a delay to discriminate between a start up surge into a large output capacitor and an actual short circuit. This voltage is then divided by two resistors R8 and R3 and applied to the gate of the transistor Q3 of the controlling circuit 412. This allows for accurate calibration of the gate threshold and provides discharge timing of the capacitor C5.

As shown in FIG. 4, the second example embodiment also includes a capacitor C12 provided in parallel between the −V_{IN} rail and the gate of the transistor Q3, and the intersection of the voltage divider made by resistors R3 and R8. Capacitor C12 stores the reduced voltage output by the voltage divider, and accordingly is able to act as a quasi-peak detector, to allow the circuit to distinguish between a surge at start-up and a short circuit.

The difference compared with the first example embodiment is that the triggering capacitor C3 AC-decouples the voltage from the resonant capacitor C401. Therefore, under no load conditions the voltage stored in the capacitor C5 is 0V (not Vin/2 as in the first example embodiment). This gives better discrimination between the threshold level of a full-load state and a short circuit. This is because the triggering capacitor C3 is a small proportion of the resonant capacitor C401. It does not greatly affect the resonant frequency and can be used to fine tune the resonant frequency if desired.

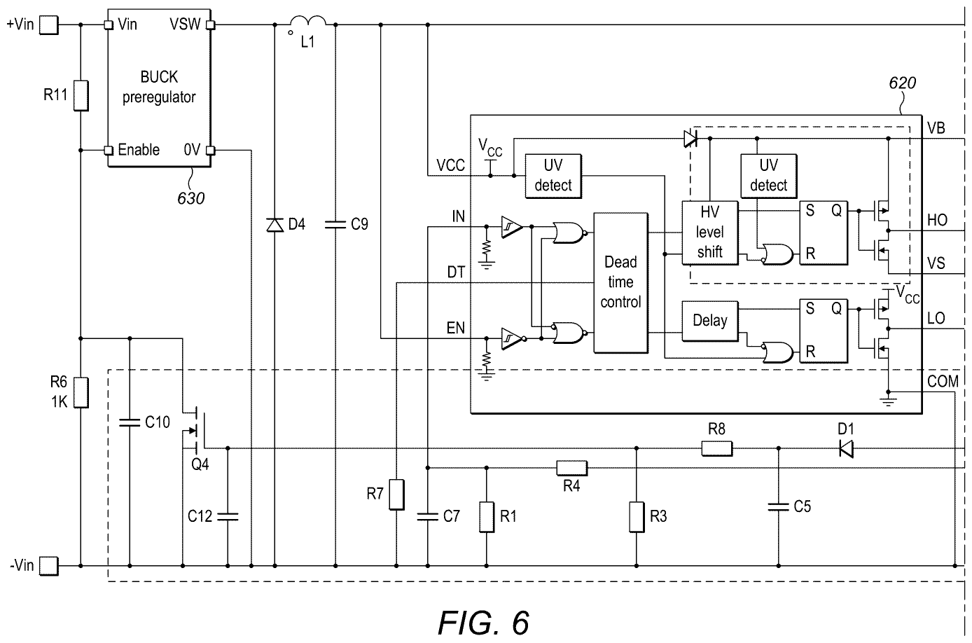

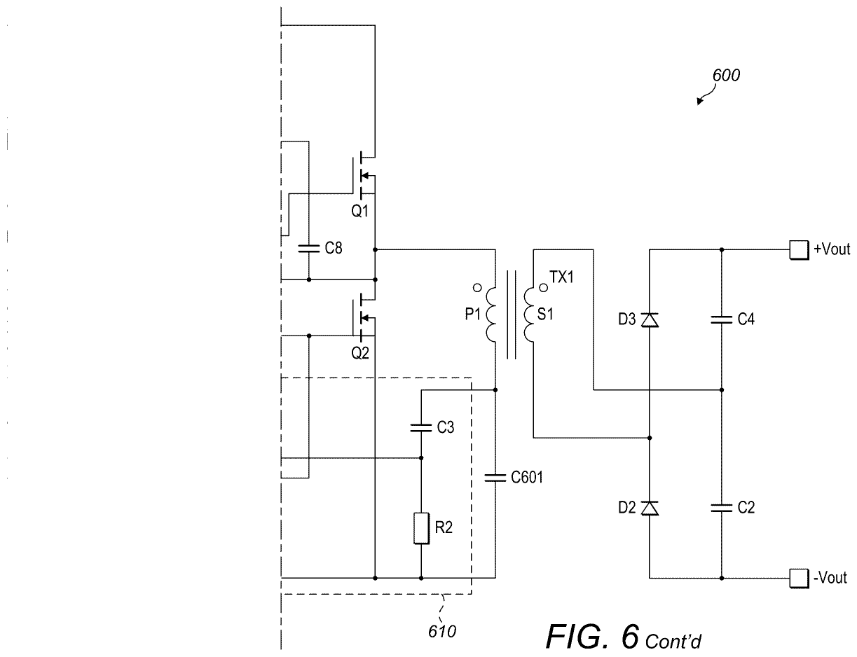

As explained below, the example embodiment of FIG. 4 can provide a hiccup mode operation. The short circuit protection circuitry of FIGS. 4 and 6 is identical, and a more detailed discussion of the hiccup mode operation is provided in connection with FIG. 6.

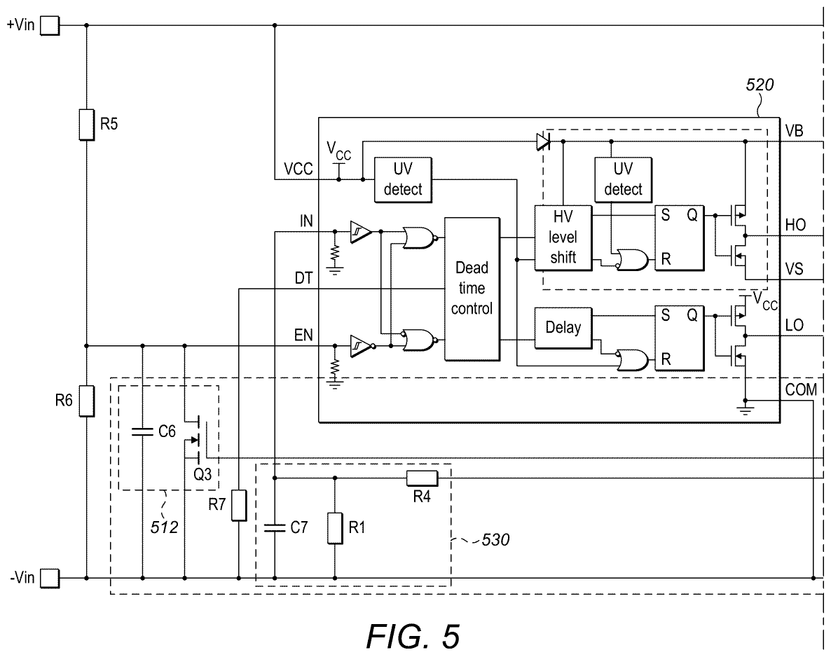

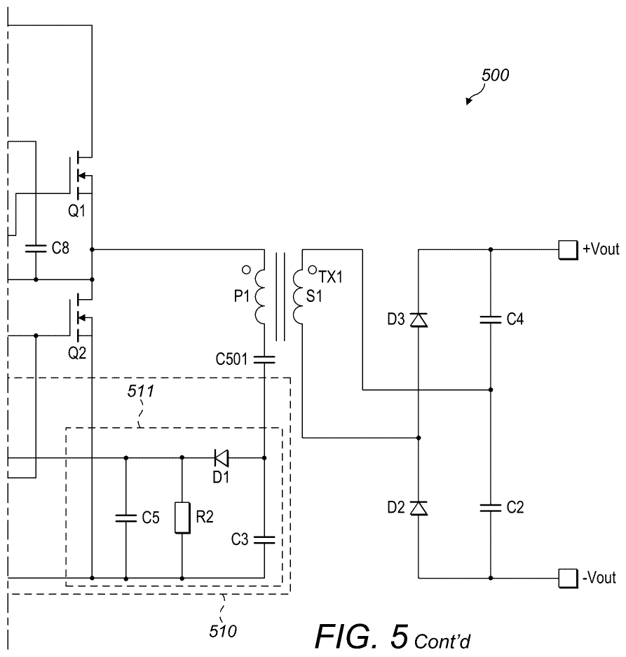

FIG. 5 shows a resonant half-bridge circuitry 500 including a short-circuit protection circuitry 510 according to a third example embodiment of the present invention. In this example embodiment, the sensing circuit 511 includes a capacitor C3 as a triggering component connected in series with the resonant capacitor C501 at the primary side. In this example embodiment, the triggering capacitor C3 has a much larger capacitance value than the capacitance of the resonant capacitor C501 (e.g., about 10 times of the capacitance of the resonant capacitor C501).

The triggering capacitor C3 and the resonant capacitor C501 provide a capacitive divider which attenuates the total voltage waveform across the series capacitors C3 and C501. This achieves a fine tuning of the threshold for current limit trigger because the series capacitor C3 is a large capacitor compared to the resonant capacitor C501. It does not greatly affect the resonant frequency.

The intermediate node of the capacitive divider is connected to diode D1 which feeds an intermediate voltage to the gate terminal of the transistor Q3. Resistor R2 and capacitor C5 may be connected in parallel with capacitor C3 between the diode D1 and the negative voltage line −Vin.

FIG. 6 shows a resonant half-bridge circuitry 600 including a short-circuit protection circuitry 610 in a real application based on the second example embodiment of the present invention shown in FIG. 4. The short-circuit protection circuitry 610 is the same as described in the second example embodiment, including at least a capacitor C3 as a triggering component in the sensing circuit and a transistor Q4 as a switch in the controlling circuit.

C3 decouples the peak to peak voltage across the resonant capacitor C601 and presents it to R2 as an ac voltage with respect to 0V. C3 and R2 are acting as a high pass filter. The value of C3 needs to be high enough to act as a sensible decoupling capacitor at the switching frequency but low enough not to influence the chosen value of the resonant capacitor C601 (which may be of the order of approximately 10 nF, for example). R2 needs to be high enough so that the high pass filter with C3 has a much lower frequency than the switching frequency (for example, approximately 10 KHz). C3 and R2 act as a first stage in the circuit to decouple the capacitor C3 from the sensing circuit C601.

D1 then rectifies the positive peak voltage of the waveform into C5. C5 is discharged by R8 and R3. The value of C5 and the total series resistance of R8 and R3 are chosen to provide enough hold up time to store a DC voltage when peak rectifying at the switching frequency (for example, 1 nF, 100 kHz). In other example embodiments different frequencies and values may be desirable. D1, C5, and R8 and R3 therefore act as a peak rectifier.

As with the second example embodiment above, R8, C12, R3 and Q4 act as a quasi-peak detector circuit. When the peak voltage in C5 is present for a long time, C12 will charge up, but if the peak voltage in C5 is only present for a short time, it will not. R8 and R2 act as a potential divider to set the appropriate gate threshold for the gate of Q4. When this is sufficiently high, Q4 is switched on. The quasi-peak detector time constant is used to ignore the short term surge current into maximum output capacitance during start up, but detect a proper long term short circuit. This time constant can be set as required across different operating temperatures and conditions.

In FIG. 6, the half-bridge circuitry 600 includes a pre-regulator 630 coupled to a gate driving IC 620. The pre-regulator 630 may be any converter such as a buck, boost or SEPIC converter (single-ended primary-inductor converter) or a linear regulator. In this case, instead of shutting down the half-bridge circuit through an EN (enabling) pin of the gate driver IC 620, the transistor Q4 as a switch in the controlling circuit is connected to a shutdown pin on the pre-regulator. The advantage of such configuration is that it introduces a natural delay into the hiccup off period due to a start up time of the pre-regulator and also it reduces the input current during the shutdown period since less circuits are powered.

R11, R10 and C10 provide a start up delay for the buck regulator 630 so that when triggered by Q4 the buck regulator will remain OFF for a predetermined time after a short circuit event. These components provide a start-up delay to the operation. In FIG. 4, although no buck regulator is shown, a similar delay function is provided by resistors R5 and R6, and capacitor C6.

The current limit protection circuit can be made to enter a hiccup mode of operation, where the on time is determined by the quasi peak detector delay time and the off time is determined by the start up delay. This duty cycle helps to reduce power dissipation during a current limit event and it is beneficial for the on time to be much shorter than the off time. In practice, the respective on time and off times must be determined for each intended implementation, and desired range of operating temperatures.

In other example embodiments, Q4 can be used to shut down the transformer directly at the EN pin of the gate driving integrated circuit as previously described, instead of using the optional buck regulator of FIG. 6. However, by shutting down the buck regulator, a beneficial additional delay in the off time can caused by the start up time of the gate driving integrated circuit in response to the buck output reaching its undervoltage lock out (UVLO) start threshold. A further advantage is that the standby current during the off time is lower if the buck is completely disabled.

According to the example embodiments described above, a short circuit protection circuit is provided in which current sensing is done by monitoring the voltage across an existing primary side decoupling capacitor. As a consequence, the protection is completely lossless and does not require a separate sense resistor or current transformer, few additional components are used, and in most cases, an existing enable pin or unused input signal pin can be used to trigger shutdown of a connected gate driver circuit. A hiccup type operation can be used to minimize the average power loss during a short circuit.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A short-circuit protection circuit for a resonant half-bridge circuit including a resonant capacitor coupled to a transformer winding of the half-bridge circuit to detect a voltage indicative of a short circuit in the half-bridge circuit, the short-circuit protection circuitry comprising:
a sensing circuit coupled to the resonant capacitor to generate a triggering voltage in response to a voltage increase across the resonant capacitor due to a short circuit in the half-bridge circuit; and
a controlling circuit coupled between a voltage input of the half-bridge circuit and the sensing circuit to shut down the half-bridge circuit when the triggering voltage is received in response to the short circuit in the half-bridge circuit.

2. The short-circuit protection circuitry according to claim 1, wherein the sensing circuit includes a first capacitor, wherein coupled to the resonant capacitor to be charged by at least a portion of the voltage across the resonant capacitor due to the short circuit.

3. The short-circuit protection circuitry according to claim 2, wherein the first capacitor is in parallel with the resonant capacitor.

4. The short-circuit protection circuitry according to claim 3, wherein the sensing circuit includes a diode coupled to the first capacitor to rectify a peak voltage from the resonant capacitor and to charge the first capacitor.

5. The short-circuit protection circuitry according to claim 4, wherein the sensing circuit includes a voltage divider coupled between the diode and the first capacitor and including a first resistor and a second resistor.

6. The short-circuit protection circuitry according to claim 3, wherein the sensing circuit includes:
a third resistor in series with the first capacitor; and
a second capacitor coupled at a node between the first capacitor and the third resistor through a diode; wherein
a voltage across the third resistor is rectified by the diode and is peak-charged to the second capacitor.

7. The short-circuit protection circuitry according to claim 6, wherein the sensing circuit includes a voltage divider coupled to the second capacitor and including a fourth resistor and a fifth resistor.

8. The short-circuit protection circuitry according to claim 6, wherein a capacitance of the first capacitor is about 10% of a capacitance of the resonant capacitor, or between about 5% and about 25% of the capacitance of the resonant capacitor.

9. The short-circuit protection circuitry according to claim 2, wherein the first capacitor is in series with the resonant capacitor to provide a capacitive divider.

10. The short-circuit protection circuitry according to claim 9, wherein the sensing circuit includes a sixth resistor coupled to a node between the resonant capacitor and the first capacitor through a diode, and a third capacitor in parallel with the sixth resistor.

11. The short-circuit protection circuitry according to claim 10, wherein the capacitance of the first capacitor is about 10 times greater than the capacitance of the resonant capacitor, or between about 5 and about 25 times greater than the capacitance of the resonant capacitor.

12. The short-circuit protection circuitry according to claim 1, wherein the controlling circuit includes a first transistor with a gate coupled to the sensing circuit, and the first transistor is configured to disable a power supply from the voltage input when the first transistor is switched on and alternatively enable a power supply from the voltage input when the first transistor is switched off.

13. The short-circuit protection circuitry according to claim 12, wherein the controlling circuit includes a second capacitor in parallel to the first transistor and in parallel to the voltage input, the second capacitor is dischargeable by the first transistor when the first transistor is switched on, and is chargeable when the second capacitor is switched off.

14. The short-circuit protection circuitry according to claim 1, wherein the controlling circuit is coupled to a gate driving circuitry of the half-bridge circuit, such that the controlling circuit shuts down the half-bridge circuitry through the gate driving circuitry.

15. The short-circuit protection circuitry according to claim 14, wherein the controlling circuit shuts down the gate driving circuitry through an enabling pin of the gate driving circuitry in response to a short circuit.

16. The short-circuit protection circuitry according to claim 1, wherein the controlling circuit is coupled to a pre-regulator of the half-bridge circuit, such that the controlling circuit shuts down the half-bridge circuitry through the pre-regulator.

17. The short-circuit protection circuitry according to claim 16, wherein the controlling circuit shuts down the pre-regulator through a shutdown pin of the pre-regulator in response to a short circuit.

18. The short-circuit protection circuitry according to claim 17, wherein the pre-regulator is one of a buck converter, a boost converter, a SEPIC converter or a linear regulator.

19. A resonant half-bridge circuit comprising:
a first half-bridge transistor and a second half-bridge transistor in a series connection including an input and an output;
a transformer with a primary winding connected to the output of the first and second half-bridge transistors;
a resonant capacitor connected to a voltage input of the half-bridge circuit;
a gate driving circuitry to drive gates of the first and second transistors; and
a short-circuit protection circuitry according to claim 1 coupled between the voltage input and the gate driving circuitry, such that the half-bridge circuit is shut down in response to a short circuit in the half-bridge circuit.

20. The half-bridge circuit according to claim 19, further comprising a duty-cycle controlling circuitry coupled to the gate driving circuitry.

21. The half-bridge circuit according to claim 20, wherein the duty-cycle controlling circuitry includes a seventh resistor coupled between an input and an output of the gate driving circuitry, such that the output is connected back to an input via the seventh resistor.

22. The half-bridge circuit according to claim 21, wherein the duty-cycle controlling circuitry includes a capacitor and a resistor coupled to the voltage input.

23. The half-bridge circuit according to claim 22, wherein the duty-cycle controlling circuitry includes an eighth resistor configured to set a deadtime control to the gate driving circuitry.

24. The half-bridge circuit according to claim 19, further comprising a regulating circuitry configured to control the half-bridge converter.

25. The half-bridge circuit according to claim 24, wherein the regulating circuitry includes one of a buck converter, a boost converter, a SEPIC converter or a linear regulator.

26. A method of short-circuit protection for a half-bridge circuit including a resonant capacitor being indicative of a short circuit in the half-bridge circuit, the method comprising:
generating, by a sensing circuit, a triggering voltage in response to a voltage increase of the resonant capacitor due to a short circuit in the half-bridge circuit;
receiving, by a controlling circuit, the triggering voltage generated by the sensing circuit, wherein the controlling circuit is coupled to the sensing circuit;
shutting down, by the controlling circuit, the half-bridge circuit in response to the received triggering voltage.
